(19) United States
(12) Patent Application Publication
(10) Pub. No.: US 2010/0174753 A1
(43) Pub. Date: Jul. 8, 2010

(54) METHOD AND APPARATUS PROVIDING FOR NORMALIZATION AND PROCESSING OF METADATA

(76) Inventor: Harold T. Goranson, Virginia Beach, VA (US)

Correspondence Address: DICKSTEIN SHAPIRO LLP, 1825 EYE STREET NW, Washington, DC, 20006-5403, US

(21) Appl. No.: 12/349,941

(22) Filed: Jan. 7, 2009

(51) Int. Cl. G06F 17/30

(52) U.S. Cl. 707/791; 707/E17.044

(57) ABSTRACT

Methods and apparatus for processing metadata of diverse data signals. Disclosed embodiments include an apparatus configured to receive a plurality of diverse data streams with accompanying metadata, recognize a source and format of the metadata, and normalize the metadata according to stored schema. A method for receiving and normalizing metadata is also disclosed.

Embodiments described herein relate generally to signal processing, and more particularly to normalization and processing of metadata from diverse data sources.

### BACKGROUND

Streaming data signals are commonly used in data (including video and audio) communication. For instance, data signals are commonly used to send information from remote sensors—such as video, audio, and other environmental sensors—from a source to one or more receiving terminals. Such sources of data signals may include, for example, remote equipment such as unmanned aerial vehicles (UAV) or medical equipment such as a magnetic resonance imaging (MRI) machine.

A data signal, such as a streaming video signal, is commonly transmitted with accompanying data that describes the signal or a portion of the signal. This accompanying data, commonly known as “metadata,” provides context to the data signal, possibly describing the data signal's origins, characteristics, content, significance, or any other aspect of the data signal or the system associated with the data signal. Metadata for a data signal may exist in one of many information standards, such as ASCII, XML, or any other type of information standard.

In a signal processing system, it may be desirable to use data from sources other than the data signal in conjunction with processing and analysis of the data signal. For example, data from other users, sources, or systems may be relevant to the data signal, or the data signal may be relevant to some aspect of the other data. Furthermore, multiple related or unrelated data signals, each having metadata, may also be received, processed, and analyzed together. The multiple data signals, as well as their respective metadata, may be transmitted and received in differing information standards. Accordingly, there is a need and desire to establish a connection with a data signal and receive data signals with accompanying metadata feeds from multiple sources and in differing formats.

Furthermore, after the metadata feeds from multiple sources are processed, a user or system may desire the data signals be output as a streaming data signal, as a data file, or both. Accordingly, there is a need and desire to recombine and further process a data signal with respective metadata after processing.

### BRIEF DESCRIPTION OF THE DRAWINGS

FIG. 1 is a block diagram of a signal processing device having a metadata processor, in accordance with an embodiment described herein.

FIG. 2 is a block diagram of a metadata processor, in accordance with an embodiment described herein.

FIG. 3 is a functional diagram of a method of processing multiple data signals with accompanying metadata, in accordance with an embodiment described herein.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. The sequence of steps is not limited to that set forth herein and may be changed or reordered, with the exception of steps necessarily occurring in a certain order.

Embodiments described herein are designed to be used with a computer system. The computer system may be any computer system, for example, a personal computer, a minicomputer, a mainframe computer, or multiple computers in a system. The computer system will typically include at least one processor, display, input device, and random access memory (RAM), but may include more or fewer of these components. The processor can be directly connected to the display, or remotely over communication lines such as telephone lines, local area networks, or any other network for data transmission. The invention may be implemented with a variety of computing hardware. Embodiments may include both commercial off-the-shelf (COTS) configurations, and special purpose systems designed to work with the embodiments disclosed herein.

Embodiments may also be implemented with other hardware. For example, embodiments may be implemented using any of the following: field programmable gate arrays (e.g., field programmable gate arrays from the Altera Stratix® series, the Actel Fusion series, or the XiLinx Virtex-5 series); graphics processing units (e.g., gaming and multimedia graphics cards such as Nvidia® GeForce® 8800 series, or ATI Radeon™ HD 4800 series); or multicore architectures (e.g., contemporary multi-core processors such as the AMD Phenom™ series or Intel® Core™ 2 series). So long as the hardware and software used is capable of performing the tasks required by specific embodiments, the embodiments are within the scope of the invention.

Disclosed embodiments provide for receipt, processing, and analysis of multiple data signals having varying formats, including a data signal having metadata, or other data sources of differing formats. Disclosed embodiments may include methods and apparatus providing source recognition, stream protocol characterization, and problem source management of metadata feeds upon receipt. Disclosed embodiments also include methods and apparatuses providing for compatibility between varying types of metadata, and any other data that may be included in the processing and analysis. This process of making the various forms of data compatible for analysis is known as “normalizing.” Finally, disclosed embodiments may include methods and apparatus for generating both internal and external messages from the normalized data.

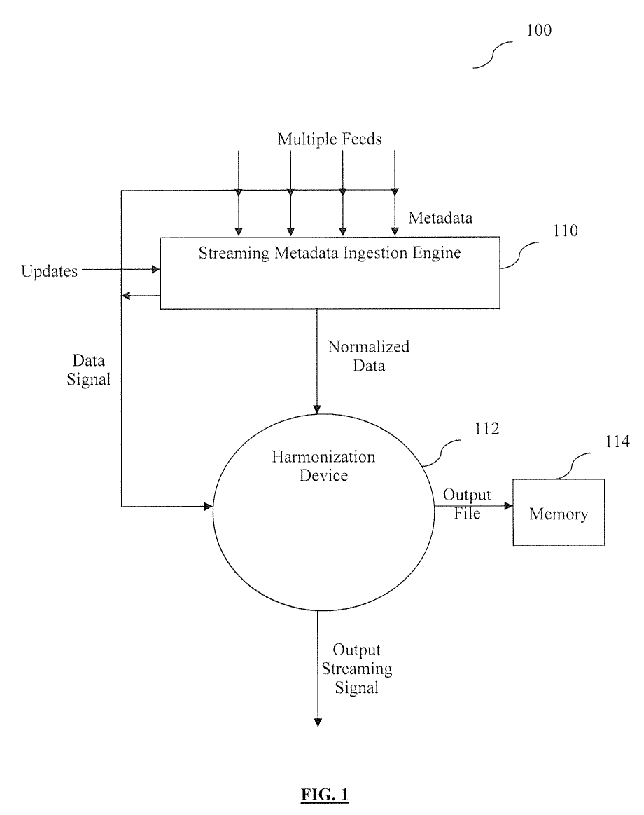

FIG. 1 is a block diagram of a signal processing device 100 having a metadata ingestion engine 110, in accordance with a disclosed embodiment. Signal processing device 100 also includes a harmonization device 112, and a memory 114.

Device 100 receives multiple data signals. The feeds may be from various independent sources, known or unknown. One or more of the feeds may include a streaming data signal, such as one or more streaming video signals. The metadata of the streaming data signal may be received on a separate channel, may be separated from the streaming data signal before input into the metadata ingestion engine 110, or may be separated by the metadata ingestion engine 110. The streaming data signal, e.g. a video signal, are passed through or diverted by the metadata ingestion engine 110. Non-streaming data and metadata from the feeds are received by the metadata ingestion engine 110.

The metadata ingestion engine 110 identifies corresponding information from the received metadata, and performs certain operations on this metadata, for instance, to establish a connection, characterize the protocol, normalize and interpret the protocol, clean and repair the signal, and certify the data.

The metadata ingestion engine 110 may receive metadata encoded in a variety of forms, for example, ASCII, XML, or any other type of data standard. To output a normalized stream of the metadata and other input data, the metadata ingestion engine 110 identifies certain designators in received metadata (e.g., a time stamp, header, or parity bit) which may exist in varying formats in the various received metadata. The metadata ingestion engine 110 normalizes the metadata by recognizing the format of the incoming data, interpreting the significance of the data, and translating this information into compatible formats which can be analyzed and output as a normalized stream by the metadata ingestion engine 110.

Normalized data is output to the harmonization device 112. The data signal, previously diverted past the metadata ingestion engine 110, or alternatively passed through the metadata ingestion engine 110 unaltered, is also input into the harmonization device 112. The harmonization device 112 combines the data signal and normalized metadata. An embodiment of harmonization device 112 may be implemented using purpose-built software running in a conventional computer environment. Embodiments of harmonization device 112 may include both commercial off-the-shelf (COTS) configurations, and special purpose systems designed to work with the embodiments disclosed herein. In an embodiment where a data signal and the accompanying metadata are received in separate channels, the harmonization device 112 also synchronizes the data signal and the accompanying metadata through known methods, such as using external knowledge about consistent delay between the respective received channels, or by comparing time stamps in the data signal with information in the accompanying metadata. One example of a method and apparatus for implementing the synchronization of data and metadata is disclosed in U.S. Pat. No. 7,333,725 B1 to Frazier.

The harmonization device 112 may deliver a file in one of several formats for encapsulation in data files or for storage in a memory as a standalone file, or be recombined by the harmonization device 112 with the data signal, and output as a streaming data signal. The harmonized file or harmonized streaming data signal may be, for instance, in MPEG 47 format, with the metadata as MPEG 7 format, and the streaming data signal as an MPEG 4 format.

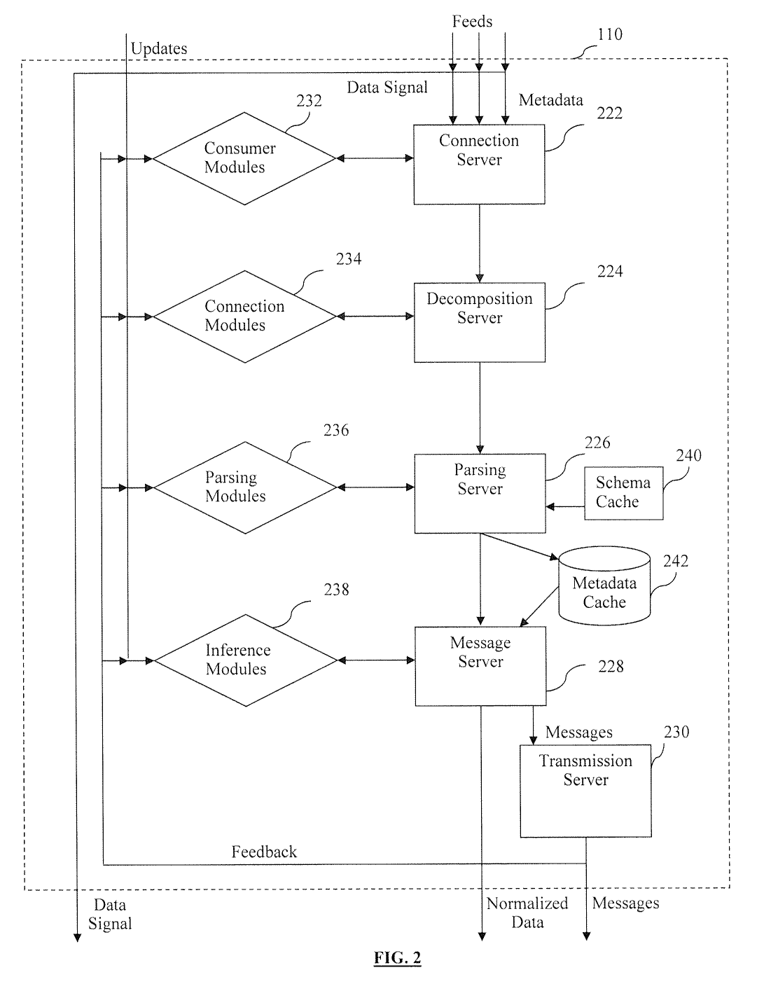

FIG. 2 shows a detailed block diagram of the metadata ingestion engine 110 shown in FIG. 1. Metadata ingestion engine 110 includes a connection server 222, a decomposition server 224, a parsing server 226, and a message server 228. Each server may interact with, and act in accordance with, one or more respective modules 232, 234, 236, 238, described further below. These modules can be updated through user input or through internal feedback from the metadata ingestion engine 110.

It should be understood that a “server” or “module” could be implemented as an independent processor, together on a single computer or integrated circuit, or in some combination thereof. All elements of the embodiments described herein may be implemented via software, hardware, or a combination thereof. In a preferred embodiment, the metadata ingestion engine 110 is implemented as computer readable software.

Metadata ingestion engine 110 receives one or multiple streaming feeds of data. Known streaming data signals and protocols are recognized by metadata ingestion engine 110, for example by detecting expected elements of various stream protocols. In one embodiment, the streaming data signals may pass through the metadata ingestion engine 110. In yet another embodiment, the streaming data signals may be separated or extracted from the metadata and diverted around the metadata ingestion engine 110. The separation may be accomplished by the connection server 222, through known software implementing demultiplexing, extraction, or separation of metadata from a data signal. Additional data for processing that is embedded in the data signal may be stripped by the metadata ingestion engine 110. The data signal can later be resynchronized with corresponding metadata, for example, by using time stamps contained in the data signal.

The metadata is received by the connection server 222. Connection server 222 is capable of receiving a variety of input feeds simultaneously. These feeds may vary in a number of ways, including varying code formats, synchronization delays, metadata formats, metadata content, security, action rules, context relationships, and end uses. Connection server 222 recognizes known input feed types and determines appropriate connection protocols for connecting to the input feeds. Connection server 222 may support automatic recognition, identification, and exception handling of the input feeds, as well as security and logging operations.

Connection server 222 may operate according to one or more consumer modules 232. Consumer modules 232 contain information about various stream protocols and provide reference information for receiving and identifying particular feeds. For instance, consumer modules 232 may specify that an incoming data signal is received by a satellite downlink with a security verification and individual password, or information specifying that the data signal and accompanying metadata are received on separate channels. Consumer modules 232 may also contain instructions for processing of received metadata feeds by connection server 222. Consumer modules 232 can be updated according to user input from elsewhere in the system, or from feedback from the connection server 222 or other elements of metadata ingestion engine 110.

In one embodiment, the connection server 222 may use a test routine to identify metadata feeds from known sources that are “subscribed” to the system of the signal processing device 100. These subscribed sources may be prioritized according to information stored in the consumer modules 232; this information may be updated externally or through internal feedback. For example, consumer modules 232 may contain information on multiple types of metadata feeds or source identifiers that are expected from a list of subscribed sources. Metadata feeds from other sources (e.g., unrecognized or suspect sources) or metadata feeds that are otherwise corrupted or encrypted may be rejected or diverted for outside analysis.

The metadata is output by the connection server 222 to the decomposition server 224. Metadata output by the connection server 222 may be of differing types, including any known key length value types, XML types, binary types, or varying packet formats. Decomposition server 224 identifies and recognizes the format of the received metadata. Thus, while the connection server identifies the source and/or protocol of the incoming metadata, the decomposition server 224 identifies the format of the metadata, for use by the parsing server 226 (discussed below).

The operations of decomposition server 224 may be controlled by one or more independent connection modules 234. Connection modules 234 contain rules, patterns, templates, and specific exceptions, along with other possible information, associated with the functions of decomposition server 224. The connection modules 234, similar to the consumer modules 232, may be updated according to user input or feedback from elements of metadata ingestion engine 110. Such feedback may include information related to the nature of the received signal itself. For example, feedback related to encryption methods or keys, identifying information about the source, and/or characterizations of the particular signal can be useful when provided to consumer modules 232 for receipt and processing of future signals.

The metadata—contained in a now recognized format—is output from the decomposition server 224 to the parsing server 226. Parsing server 226 breaks down the metadata in terms of discrete portions of information, referred to herein as “atoms.” Parsing server 226 then normalizes the discrete atoms of metadata contained in the metadata feeds, providing semantic interpretation and processing of the metadata and information by processes or users in a system. Operation of the parsing server 226 may be controlled by parsing modules 236.

The semantic interpretation is performed by the parsing server according to translation schema. The schema—containing rules, definitions, and other information for parsing and normalizing the metadata feeds—may be maintained in a cache, shown as schema cache 240. Alternatively, the schema may be maintained in parsing server 226. The parsing server 226 receives each atom from the decomposition server 224, compares the atom to the relevant schema stored in schema cache 240, and produces a translation into a common format (i.e., normalized metadata) of the information contained in the atom.

Parsing server 226 may also provide for some immediate analysis on the normalized metadata. The parsing server 226 may identify information to be designated by a marker indicating that the information is an “item of interest,” i.e., metadata indicating a particular object, event, time, place, or metadata of any other element or characteristic that has been previously identified by an existing set of rules (for instance, in the parsing modules 238) to trigger alerts or further analysis.

The depth of the immediate analysis performed on the normalized metadata in the parsing server 226 may be adjustable, depending upon the desired processing speed (i.e., whether the user wants near real-time throughput from metadata ingestion engine 110, or is willing to compromise on time in exchange for more in depth immediate analysis). For near real-time analysis, parsing server 226 may flag for messaging metadata of a requested time and place previously input by a user into parsing modules 236. For more in depth (and potentially more time-consuming) analysis, the normalized metadata may be passed to a metadata cache 242. This analysis may include, for example, evaluation of newly input metadata with cumulative metadata stored in the metadata cache 242.

The normalized metadata is input to the message server 228. Message server 228 generates alerts and other messages based upon the immediate analysis performed by the parsing server 226. Message server 228 applies rules and inferences received from inference modules 238 to determine messages to be generated and output, either to human analysts or other outside users. Rules and inferences maintained and updated in inference modules 238 may include identification of conditions that would merit an alert, creation of new information for storage in a corresponding data signal file, and repair of damaged or corrupted metadata.

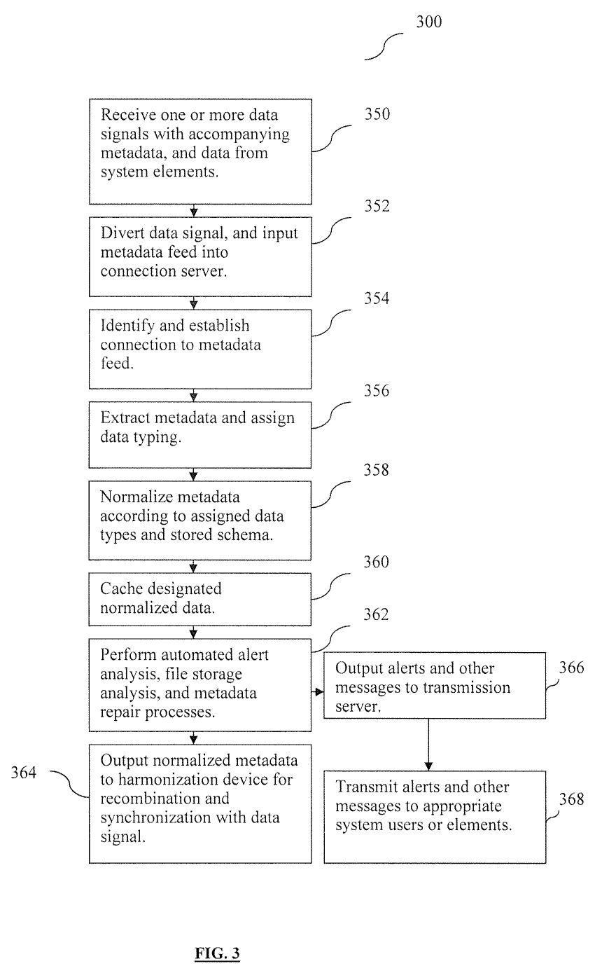

Message server 228 may also be configured to create data files, such as video files. These files may be used for processing and analysis of future metadata by the metadata ingestion engine 110. For example, information may be added to a metadata type in step 356 (as shown in FIG. 3), this information not existing in either the metadata feed or the accompanying data signal. In the example of an umnanned aerial vehicle (UAV) system, information added to data types may track a “curiosity index” of certain system users or operations. The curiosity index identifies objects or occurrences of interest not normally generating alert messages, but which can be tagged for further analysis. In one embodiment, the curiosity index includes various user-defined ranks or thresholds that allow the generation of hierarchies or networks of objects which are of particular interest for further analysis. For example, if an analyst was seeking the location of a covert construction sight, the analyst could input a curiosity index if several UAV's detected an unusual amount of activity in a certain area where previously there was none. If normalized metadata from several UAV's indicates such an occurrence, the metadata may be tagged for further analysis by message server 228.

Furthermore, message server 228 may also be configured to repair normalized metadata. Segments of the metadata streams may be damaged because of poor transmission, unfavorable conditions, faulty equipment, or spoof signals. Many of these damaged or missing segments can be reconstructed based on inferred rules, as indicated by inference modules 238. For example, a segment of metadata from a sensor on the UAV that reports the global-positioning satellite (GPS) location of the UAV may be damaged or missing. The segment may be reconstructed according to interpolation of previous and future GPS locations.

Message server 228 outputs messages generated to transmission server 230. Transmission server 230 may output messages to an archiving system, to human analysts or other users, or as feedback to update the other modules (232, 234, 236, 238) in the metadata ingestion engine 110. The messages may be in the form of text messages, audio messages, or any other form of message that can be generated and output by a computer system.

Message server 228 outputs the normalized metadata to the harmonization device 112 (FIG. 1). The normalized metadata may also be enhanced or amplified by the message server 228 before being output to the harmonization device 112.

FIG. 3 is a block diagram of a method 300 for normalizing and processing metadata from a data signal received from a source, in accordance with an embodiment of a signal processing device 100 described above in FIGS. 1 and 2.

In step 350, multiple data signals are received by signal processing device 100. One of the data signals is a streaming video signal from a particular source. Different sources may use different combinations of video technologies, transmission means, data signal formats, and metadata formats. For instance, a data signal from an unmanned aerial vehicle (UAV) may consist of raw, uncompressed video and a key-length-value (KLV) encoded stream of metadata delivered by a separate channel. In this UAV example, because the video signal and metadata feeds are received on separate channels, the video signal and metadata feed are unsynchronized. For example, time stamp information, as well as information relating to the direction, attitude, status, and/or performance of a source, all may be time-sensitive, and yet may be received asynchronously with respect to the associated corresponding signal information (e.g., the corresponding image signal).

In other embodiments, the video signal and accompanying metadata feed may be received on the same channel, and may be multiplexed. For example, the MPEG-4 Video Standard by the Moving Pictures Expert Group (available at http://www.chiariglione.org/mpeg/standards/mpeg-4/mpeg-4.htm, last visited Oct. 13, 2008) includes provisions for packaging and/or multiplexing text and other metadata information with a digital signal. Metadata combined with signal information can be separated through known methods of extraction or demultiplexing.

In one embodiment of the invention, information identifying known sources and known types of metadata feeds is also communicated to connection server 222 from consumer modules 232 in step 350. The information identifying known sources and known types of metadata feeds stored in consumer modules 232 may be updated through feedback and user input, as discussed above.

In step 352, the data signal (i.e., video signal) bypasses or is passed through the metadata ingestion engine 110 unaltered, while the metadata of the data signal is input into the connection server 222 (FIG. 2) of the metadata ingestion engine 110. In the example of a video signal, because the streaming video and metadata are received on a separate channel, the video signal may simply be routed past the metadata ingestion engine 110, while the metadata stream is input to the connection server 222. In another example, as discussed above, the data signal and metadata may be received as a combined signal, and may be demultiplexed or extracted, for example by known methods.

In step 354, a connection with the metadata feed is established. Initially, the source is identified, for instance, by connection server 222 of metadata ingestion engine 110. Connection server 222 may perform security, access, and logging operations to identify and determine the propriety of the metadata feed. For example, connection server 222 may detect and evaluate a signature contained within the metadata feed. If the metadata feed is not from a recognized or trusted source, or for some other reason is suspect, the metadata feed and the corresponding data signal may be discarded or output for further analysis.

In step 356, the format of the metadata feed is identified, and a data typing is assigned to the metadata feed. For instance, decomposition server 224 may use rules and inferences contained in connection modules 234 to recognize that the communication protocol used to transfer the metadata may be identified as a secure internet protocol, requiring an internet connection, security services, and extraction protocols for extracting the conveyed data from internet protocol packets. In the example of a UAV signal, it is known that a certain type of UAV transmits a signal with metadata having a certain format of KLV encoding.

Further in step 356, internal references, herein referred to as “data types,” may be used for labeling the metadata. For example, KLV data may use a different timing format than is desired for analysis and processing of normalized data in the signal processing device 100 (FIG. 1). Thus, a data type is assigned to identify the metadata for facilitating normalization of the metadata. Data types may also indicate whether a portion of the metadata should be stored in metadata cache 242 (see step 362). The data typing may be maintained and updated, for example, from connection modules 234 (FIG. 2).

In step 358, the metadata is normalized according to stored schema and assigned data types. The schema may be received from a schema cache 240 (FIG. 2), and include semantic information about the content of the metadata. The schema may include algorithms for converting alphanumeric data, or other translation algorithms.

In step 360, immediate analysis of the normalized data may be performed, for example, as described above with regard to parsing server 226. As described above, this immediate analysis is performed within an acceptable time delay, so that the normalized metadata is output by the metadata processor at a rate sufficient to limit the time delay specified by the user for receiving the streaming data signal with normalized metadata.

In step 361, portions or all of the normalized metadata may be stored in metadata cache 242. Portions of the metadata may be designated for storage in metadata cache 242 after normalization by data typing at step 356, or may otherwise be recognized as an “item of interest” by the metadata cache 242.

In step 362, alert messages may be generated based upon the normalized metadata and immediate analysis. The alert messages may be generated, for instance, by message server 228, according to dynamic rules, methods, exceptions defined by inference modules 238. The analyses performed in step 362 may include identification of conditions that would merit an output message. For example, a system user or automated recognition process may identify an object in a previous video signal as an “object of interest.” Other data streams received by the metadata ingestion engine 110 may have other information indicating that the object of interest is a threat, or otherwise merits an alert or action. Message server 228, using the information received from inference modules 238, recognizes the relationship between the respective normalized information from the two data signals, formats a message for output, and outputs that message.

In step 366, messages and data files generated in step 362 are output to a transmission server 230 (FIG. 2). In step 368, the transmission server 230 outputs the messages and files to other locations, both within the metadata ingestion engine 110 (in the form of feedback) and externally to human analysts, other computers, or storage. The output messages may be, for example, for alerting or analysis purposes. For example, in a UAV system, the messages may send an alert to other military installations of an impending threat or target locations.

In step 364, the normalized metadata stream is output by message server 228 (FIG. 2) to harmonization device 112 (FIG. 1). The normalized metadata is recombined and synchronized with the data signal, e.g., the UAV streaming video signal, through known methods in harmonization device 112, and the streaming video signal is then output for use in the device 100.

As discussed above, the embodiments described herein may be implemented in a system performing signal processing of multiple signals having metadata, such as, for example, signals from unmanned aerial vehicles (UAVs), satellites, ground sensors, naval ships, and other intelligence collection platforms.

Embodiments may also be implemented in systems for receiving data signals from medical equipment. Signal processing device 100 and other described embodiments allow for the reception of data signals (including both streaming and non-streaming data) from medical equipment, such as a magnetic resonance imaging (MRI) machine, having disparate metadata, and allowing for identification, normalization, and immediate analysis of the metadata. For example, in one embodiment, medical equipment such as an MRI machine is connected to a network, and generates signals including corresponding metadata. The signals are received by metadata ingestion engine 110 via the network, for processing as described above. Users may interact with the information generated using a purpose-built user interface, allowing medical professionals to view as much diagnostic information for a patient as possible in a normalized format, and to receive alert messages based upon real-time analysis of continuous data signals. Furthermore, embodiments of the signal processing device 100 could allow for large-scale cumulative analysis and cooperation in treatment of large populations, such as in public health applications and epidemiological studies.

It should be understood that embodiments are not limited to these examples, but can be used in any system where normalization of metadata from multiple sources to a common format is desirable. The above described embodiments provide an apparatus and method that enable a user to organize diverse information in systems to convey a large and diverse collection of associations. The above description and drawings illustrate embodiments which achieve the objects, features, and advantages described. Although certain advantages and embodiments have been described above, those skilled in the art will recognize that substitutions, additions, deletions, modifications and/or other changes may be made.

What is claimed as new and desired to be protected by Letters Patent of the United States is:

1. A processing system for normalizing metadata received by said processing system from at least one data signal source, said processing system comprising:
at least one connection server for establishing a connection to at least one data signal source that produces a data signal that includes the metadata;
at least one decomposition server for identifying a format of the metadata;
at least one parsing server for normalizing the metadata into a designated format; and
at least one message server which outputs the normalized metadata and generates messages based on the normalized metadata,
wherein the normalized metadata provides for analysis of the metadata from the data signal source with metadata from at least one other data signal source.

2. The processing system of claim 1, further comprising:
one or more consumer modules connected to the at least one connection server containing information for receiving the metadata and identifying the at least one data signal source;
one or more connection modules connected to the at least one decomposition server containing information for identifying the format of the metadata;
a schema cache connected to the at least one parsing server containing information for normalizing the metadata;
one or more parsing modules connected to the at least one parsing device containing information for analyzing the normalized metadata; and
one or more inference modules connected to the message device containing information for generating messages regarding the normalized metadata.

3. The processing system of claim 1, wherein the at least one connection server is configured to establish connections to a plurality of data signal sources.

4. The processing system of claim 1, wherein the normalized metadata is output by the at least one message server to a harmonization device for recombining with the data signal.

5. The processing system of claim 1 further comprising:
at least one transmission server for receiving and outputting the messages received from the at least one message server.

6. The processing system of claim 5, wherein the at least one transmission server outputs the messages to one or more external sources.

7. The processing system of claim 5, wherein the at least one transmission server provides feedback to at least one other element of the processing system.

8. The processing system of claim 2, wherein at least one of the consumer modules, connection modules, parsing modules, inference modules, and schema cache is configured to receive information that is input by a user of the processing system.

9. The processing system of claim 2, wherein at least one of the consumer modules, connection modules, parsing modules, inference modules, and schema cache is configured to receive information from another element within the processing system.

10. The processing system of claim 1, wherein the at least one parsing server is configured to designate portions of the metadata for further analysis.

11. The processing system of claim 1, wherein the at least one parsing server is configured to designate portions of the metadata to be output in messages.

12. The processing system of claim 1, wherein the at least one message server is further configured to create data files from the normalized metadata for future analysis.

13. The processing system of claim 1, wherein the at least one message server is further configured to repair corrupted portions of the metadata.

14. The processing system of claim 1, wherein the processing system is included in a signal processing system, the signal processing system further comprising:
a harmonization device for recombining the metadata with the accompanying data signal, wherein the harmonization device is configured to perform at least one of:
outputting the synchronized metadata and data signal as a streaming data signal with normalized metadata; and
outputting the synchronized metadata and data signal as a data file; and
a memory configured to receive data files from the harmonization device.

15. The processing system of claim 14, wherein the signal processing system is configured to receive data signals from an unmanned aerial vehicle.

16. The processor of claim 14, wherein the signal processing system is configured to receive data signals from medical equipment.

17. A method for processing one or more data signals with accompanying metadata, the method comprising:
receiving the one or more data signals with accompanying metadata;
identifying a source of the one or more data signals;
identifying a format of the accompanying metadata;
normalizing the accompanying metadata according to stored schema; and
generating messages based on rules applied to the normalized metadata.

18. The method of claim 17, further comprising:
synchronizing and combining the normalized metadata with the corresponding data signal.

19. The method of claim 18, further comprising:
outputting the synchronized metadata and data signal as a streaming data signal with normalized metadata.

20. The method of claim 18, further comprising:
outputting the synchronized metadata and data signal as a data file.

21. The method of claim 17, wherein the source of the data signal is identified by a signature contained in the metadata.

22. The method of claim 17, further comprising:
providing information to a module configured to maintain information related to at least one of the following:
identifying the source of the metadata;
identifying the format of the metadata;
normalizing the metadata;
analyzing the content of the metadata;
generating messages based on content of the metadata.

23. The method of claim 22, wherein the information provided to the at least one module is provided by a human analyst.

24. The method of claim 22, wherein the information provided to the at least one module is provided by feedback.

25. The method of claim 17, further comprising:
providing information to least one cache used to normalize the metadata.

26. The method of claim 17, further comprising:
storing a portion of the normalized metadata for future analysis.

27. The method of claim 18, further comprising:
performing analysis on the normalized metadata prior to synchronizing the metadata and data signal.

28. The method of claim 17, wherein at least one of the one or more data signals is a streaming video signal.

29. The method of claim 17, wherein at least one of the one or more data signals is output by a sensor.

30. The method of claim 17, wherein at least one of the one or more data signals is output by a medical detection device.

31. The method of claim 28, wherein at least one of the one or more streaming video signals is output by an unmanned aerial vehicle.

32. The method of claim 17, wherein at least one of the one or more data signals includes an accompanying key-length-value encoded stream of metadata.
